(19) United States
(12) Patent Application Publication
(10) Pub. No.: US 2009/0198666 A1
(43) Pub. Date: Aug. 6, 2009

(54) Affinity matching system and method

(76) Inventors: Ronald H. Winston, New York, NY (US); Manuel (Laurent) Barbero, New York, NY (US)

Correspondence Address: Edwards Angell Palmer & Dodge LLP, P.O. Box 55874, Boston, MA, 02205, US

(21) Appl. No.: 12/012,335

(22) Filed: Feb. 1, 2008

(51) Int. Cl. G06F 17/30; G06F 7/06

(52) U.S. Cl. 707/5; 707/E17.014; 707/E17.108

(57) ABSTRACT

An affinity matching system and method for identifying nearby users with shared affinities including a data processing system comprising a computer program tangibly embodied on a memory device. The computer program includes an affinity user group preprocessing module configured to define at least one affinity user group, each affinity user group comprising a plurality of user profiles of users having matching affinities. The preprocessed affinity user groups are available for processing by the affinity matching system in response to match queries in real-time. The user profile includes an affinity profile of a user. The computer program also includes a request module configured to accept an affinity request, the affinity request comprising a match query. The computer program also includes an affinity matching module coupled to the request module and configured to process the affinity request to determine at least one matching user profile within the at least one preprocessed affinity user groups based on the match query. The match query may further incorporate weight factors expressing the importance of affinities, geographic proximity, and match time for matched users. A rendering module is coupled to the affinity matching module and configured to present the at least one matching user profile.

### TECHNICAL FIELD

The invention generally relates to matching systems using time and location to identify, classify, track, and communicate with user populations over a network.

### BACKGROUND INFORMATION

Existing matching systems are primarily proximity or location based. Affinity matching systems generally include keyword searching based on user attribute information such as gender, race, etc. Most of these systems leverage mobile communications technologies for voice and data networks. A variety of user-to-user messaging technologies and services are available, for example Instant Messaging (i.e, IM), text messaging (i.e. SMS), and email (e.g., Outlook). These technologies maintain privacy using security and authentication through a variety of techniques, such as user registration and secure login, and data encryption.

Matching systems use relational database management systems to input, store, organize, and query information. For ease-of-use and device portability, many systems leverage browser-based interfaces for entering and displaying of information, such as match input data and results.

Location-enabled matching systems use existing location-based technologies such as Global Positioning Systems (GPS), or third-party location services to retrieve and match up user geographic coordinates.

### SUMMARY OF THE INVENTION

The purpose and advantages of the present invention will be set forth in and become apparent from the description that follows. Additional advantages of the invention will be realized and attained by the apparatuses and methods particularly pointed out in the written description and claims hereof, as well as from the drawings.

The various embodiments of the present invention provide an affinity matching system or method for identifying users with shared affinities. The affinity matching system includes a data processing system for applying match criteria to user affinity and attribute information, preferably stored in a relational database. Individual users enter the affinity and attribute information, although other agents could also enter the information. Users can select from a variety of presented affinities to save in affinity profiles. Users also can enter demographic information, such as gender, age, and home address.

The data processing system has access to affinity definitions, for example, sets of affinity keywords organized in a data hierarchy. The base of the hierarchy includes broad affinity definitions such as sports, music, food, etc. The broad definitions are subdivided into more specific affinities, such as baseball, hockey, and football under sports. The affinities are further subdivided until a bottom tier is reached, for example, an affinity for the New York Yankees Major League Baseball team, or the musician Bruce Springsteen. Affinity can be organized into other formats, for example, data matrices, linked lists, and arrays.

A user can setup his or her affinities using the data processing system to access and select the affinities defined in the affinity hierarchy. The data processing system preprocesses the user-defined affinites to define affinity user groups for grouping all users having a particular affinity. For example, the affinity user group can reference all users with an affinity for sports, baseball, or for the New York Yankees.

The affinity matching system can use the preprocessed affinity user groups for performing real-time, or near real-time match queries. Preferably, a user on a client device enters a set of desired match information. The client device can format the match information as an affinity request including a match query. The client device sends the affinity request to the data processing system, although the affinity request may come from a third party application, such as a search engine or social networking web site.

Upon receipt of the match query, the data processing system can parse the match query into match parameters and combine the match parameters with real-time information. The real-time information preferably includes proximity and time information for other users of the affinity matching system. Proximity information includes a geographic location computed by a Geographic Positioning System (GPS) or saved as a static address, for example the address of a home or commercial establishment. The geographic location information is combined with time tracking.

The data processing system uses the match information to find other users with the desired affinities and attributes. The data processing system further defines users within a certain proximity to a user issuing the affinity match request. The data processing system can ensure that the proximity information is up-to-date using timestamp information.

A set of active users that have matching attributes to the query is returned or presented to the client device or web service. The data processing system is device agnostic, and can conform the presented information based on the capabilities and limitations of the client device. Furthermore, the data processing system is network agnostic, and can conform information communication to the capabilities and limitations of the communications network.

One advantage of the affinity matching system is that by preprocessing the user affinities and attribute information for all users in the system, affinity requests can be processed in real-time or near real-time because the affinity information is already readily available to the matching system. For example, the affinity processing system can match affinity keywords in the query with affinity keywords for the preprocessed affinity user groups. Once the affinity matching system finds a match in response to the user query, the affinity matching system need only obtain and return to the querying user the list of referenced users in the preprocessed affinity matching groups. Preprocessing the affinity user groups not only saves time, but also minimizes load on the server, allowing the server to process many more requests simultaneously.

Another advantage is that the affinity processing system does not need to process the affinity user groups on a request-by-request basis, which saves computer resources and reduces the overall load on the server. Also, the preprocessed affinity user groups can be transmitted to other web services for sharing. The affinity matching system can temporarily store any user affinity updates or inserts, and update the affinity user groups during off-peak usage periods.

A further advantage of the affinity matching system is that users can apply weight factors to a match query. For example, a user can define separate weight factors for the desired affinity, proximity to other users, and when to expire the match. For example, a user who must walk to meet other users may rank the proximity factor the highest rank. Users who possess a particularly strong interest in something, for example, the Boston Red Sox baseball team, may rank a shared affinity for the team the highest rank. Users under severe time restraints may rank the time to expire the match request the highest rank. Thus, the user has flexibility in specifying the relative importance of affinity criteria in finding matches.

Another advantage of the affinity matching system is that users can choose whether to share their affinities with other users on the system. Also, users can choose whether they can issue affinity requests. The user can select from among a variety of user modes defining how the system shares information and the ability to issue requests. This provides the user with flexibility in system usage. For example, a user may decide to be a secret observer of other users without allowing the other users to view his or her information. This may be particularly important if the user has safety or privacy concerns. The user can also choose to block particular users from accessing his or her information.

A further advantage of the affinity matching system is that it is device and network agnostic. This allows users to access the system from virtually any client device or network technology. For example, a user on a telephone may listen to a set of vocalized options for selecting matching users. A user on a data-only device may view a list of matching users. Furthermore, a user can access the system over a mobile device using wireless communications, or over a landline network from a home desktop.

To achieve these and other advantages in accordance with the purpose of the invention, as embodied herein, the invention includes an affinity matching system for identifying nearby users with matching affinities. Each user has a user profile including an affinity profile of the user for relating the user's interests and attributes.

The affinity matching system includes a data processing system comprising a computer program tangibly embodied on a memory device. The computer program includes an affinity user group preprocessing module configured to define affinity user groups. The affinity user groups reference users having matching affinities. The affinity user group preprocessing module uses a match algorithm to preprocess user affinities based on match criteria. The match criteria may include keywords describing affinities, for example, sports or music. The affinities may be related to each other using an affinity keyword hierarchy.

The computer program also includes a request module configured to accept an affinity request. The affinity request includes a match query for including desired match information.

The computer program also includes an affinity matching module coupled to the request module and configured to process the affinity request to determine matching user profiles within the affinity user group, based on the match query.

The computer program also includes a rendering module coupled to the affinity matching module and configured to present the matching user profiles. For example, a web service routing an affinity match to a user's client device.

In accordance with a further aspect of the invention, the data processing system includes a requester location, a request time, a maximum distance parameter, and a time limit parameter. Each of the matching user profiles has a tracked location. Furthermore, the affinity matching module is configured to define active user profiles based on whether the calculated distance between the requester location and the tracked location of a matching user profile is less than or equal to the maximum distance parameter. Also, the affinity matching system defines the active user profiles based on whether the calculated time difference between the request time and the current time is less than or equal to the time limit parameter. The rendering module is further configured to present the active user profiles.

In accordance with another aspect of the invention, the maximum distance parameter is 100 yards, a quarter mile, a half mile, or one mile.

In accordance with a further aspect of the invention, the time limit parameter is one hour, six hours, 12 hours, or 24 hours.

In accordance with another aspect of the invention, the affinity matching module is further configured to update the requester location and the tracked location of the matching user profiles after the expiration of a length of time. After the update, the affinity matching system redefines the active user profiles using the updated information. In still a further aspect of the invention, the length of time is one second, one minute, or one hour.

In accordance with further aspect of the invention, the tracked location of the matching user profiles has a tracked time. Also, the affinity matching module is further configured to define the active user profiles based on the tracked time and to update the, tracked time.

In accordance with a further aspect of the invention, the data processing system includes a requester location, and a request time. The match query further includes an affinity weight factor, a distance weight factor, and a time weight factor. Each of the matching user profiles has a tracked location and a match weight. The affinity matching module is further configured to calculate a distance between the requester location and the tracked location of the matching user profiles. Also, the affinity matching module calculates a time difference between the request time and a current time. The affinity matching module uses the results to calculate the match weight of each matching user profile. Each matching user profile's match weight is based on a sum of:
an affinity strength of the matching user profile modified by the affinity weight factor. The affinity strength represents the strength of the match between the affinity request and the affinity of the matching user profile;
the calculated distance the matching user profile modified by the distance weight factor; and
the calculated time of the at least one matching user profile modified by the time weight factor.

In still a further embodiment of the invention, the match query further includes an expressed order of importance for the affinity weight factor, the distance weight factor, and the time weight factor. The user expresses the order of importance and the affinity matching module is further configured to calculate the match weight of each matching user profile based on the order of importance. In still a further embodiment, the affinity matching system is further configured to rank the matching user profiles based on each of the profile's match weight. The rendering module is further configured to present the ranked matching user profiles.

In accordance with a further embodiment of the invention, the affinity strength is a number in the range of 0 to 1, the affinity weight factor is a number in the range of 0 to 1, the distance weight factor is a number in the range of 0 to 1, and the time weight factor is a number in the range of 0 to 1. The affinity matching module is further configured to rank the matching user profiles based on each profile's match weight. The rendering module is further configured to present at least one of the ranked matching user profiles.

In accordance with another embodiment of the invention, each of the affinity profiles is associated with affinity key words. The affinity strength of each matching user profile is based on a number of matching keys words in the matching user profile's affinity user group.

In accordance with a further embodiment of the invention, the rendering module presents the matching user profiles as prerecorded vocalizations.

In accordance with another embodiment of the invention, the rendering module presents the matching user profiles as textual information.

In accordance with a further embodiment of the invention, the user profiles further comprise user personae for defining at least one role-playing attribute of the user. The user personae can be directed to a variety of user affinities and attributes. For example, the user personae may include the user's occupational information. The user personae may be directed to the user's character in a role-playing game or the user's avatar in a virtual reality system.

In accordance with another embodiment of the invention, each of the user profiles further comprises a demographic profile. The demographic profiles can include user information such as age, name, gender, home address, occupation, income level, race, any disabilities, etc.

In accordance with a further embodiment of the invention, the affinity matching system further includes user modes for defining system usage. One of the user modes includes a user idle mode in which at least one system user's profile is not shared and the system user cannot issue the affinity request. Another user mode includes a user active-browse mode in which at least one system user's profile is shared and the system user can issue the affinity request. Another user mode includes a user active-silent (or “secret observer”) mode in which at least one of the user profiles is not shared and the system user can issue the affinity request.

The invention also provides a method of matching users with shared affinities. The method includes storing a user profile, which includes a demographic profile of a user and an affinity profile of the user. The method also includes predefining affinity user groups representing matching affinity profiles of users. The affinity user group can reference each of the matching affinity users, for example, by including a unique id for each user. The method also includes accepting an affinity request which includes a match query, and determining matching affinity user groups within the predefined affinity user groups based on the match query. The method also includes presenting matching user profiles in each of the matching affinity user groups.

In accordance with a further embodiment of the invention, the method further includes accepting a request to contact at least one user based on the presented matching user profile. The request may originate from a client device of a user of the affinity matching system. In another embodiment, the request originates from a web application, for example, a search engine, social networking web site, or any application requiring match information. The request can include a unique id of the user to contact. The request may also include a message to send to the user, including permission to contact the user, and a verification that the request reached the intended destination. In still a further embodiment of the invention, the request to contact includes a user profile sharing value indicating whether to share a user's profile.

The method further includes contacting the user. The contact may be initiated after an initial contact between one or more users, and may include more detailed information, such as information regarding affinities and attributes of the users. In still a further embodiment of the invention, the step of contacting includes information on a scheduled meeting between users.

The invention also provides a method of matching users with shared affinities including the step of entering a user profile. The user profile includes a demographic user profile of a user and an affinity user profile including information on affinities of the user. The method also includes issuing a request having a match query with desired match information. The method also includes viewing matching user profiles based on the match query.

In accordance with a further embodiment of the invention, the match query includes a maximum distance parameter indicating a maximum distance between a requester user and the at least one matching user profile. The match query also includes a time limit parameter indicating a length of time for performing the match query. The length of time is calculated as a difference between a request time and a current time.

In accordance with another embodiment of the invention, the method further includes specifying as a portion of the match query, an affinity weight factor, a distance weight factor, and a time weight factor. In still a further embodiment of the invention, the step of specifying further includes specifying as a portion of the match query, an order of importance of the affinity weight factor, the distance weight factor, and the time weight factor.

In accordance with a further embodiment of the invention, the method further includes issuing a request to contact users with matching user profiles and scheduling a meeting with the users.

It is to be understood that both the foregoing general description and the following description are exemplary and are intended to provide further explanation of the invention claimed.

The accompanying figures, which are incorporated in and constitute part of this specification, are included to illustrate and provide a further understanding of the apparatus and method of the invention. Together with the description, the drawings serve to explain the principles of the invention.

### BRIEF DESCRIPTION OF THE DRAWINGS

The following description, given by way of example, but not intended to limit the invention to the specific embodiments described, may be understood in conjunction with the accompanying drawings, incorporated herein by reference. Various preferred embodiments of the present invention will be described by way of non-limiting examples and with reference to the accompanying drawings in which:

FIG. 1 illustrates an embodiment of a networked system architecture used to practice the invention;

FIG. 2 depicts an embodiment of the affinity matching system including a data processing system comprising a computer program;

FIG. 3A illustrates an embodiment of a database architecture used to practice the invention shown in FIG. 2;

FIG. 3B illustrates an embodiment of an affinity hierarchy used to practice the invention shown in FIG. 2;

FIG. 3C illustrates an embodiment of preprocessed affinity user groups used to practice the invention shown in FIG. 2;

FIG. 4 depicts an embodiment of the invention for executing a real-time use-case scenario for practicing the invention;

FIG. 5 illustrates an embodiment of a method of practicing the invention using a client device or web service; and

FIG. 6 illustrates an embodiment of a method of practicing the invention using server-side data processing system.

### DETAILED DESCRIPTION OF THE PREFERRED EMBODIMENTS

### I. Definitions

The term “affinity” is meant to include a similarity or likeness between individuals or groups of individuals. Affinity may include common goals and interests between the individuals. Affinity may further include common occupations or may reference characteristics and relationships between individuals and environments within which the individuals operate, such as role-playing environments and virtual environments.

The term “match” or “matching” is meant to describe an existing similarity between individuals or groups of individuals based on for example, the affinities and attributes of the individuals. A match may be determined using various methods with varying levels of particularity and detail. A match or matching individuals may have broadly defined shared interests or affinities, for example, a general interest in sports. A match or matching individuals may share very narrowly defined interests, such as an interest in an individual sports teams or an athlete. A match may be determined using a variety of methods such as fuzzy logic or by comparison of keyword definitions of affinities.

The term “requester” is meant to include an individual or entity originating a request, such as a request over a network from a client device or web site. Although the requester originates the request, the requester may be responding to an earlier request from another individual. The request may be conducted in real-time, i.e., it may reach the destination as quickly as the network or communications medium provides, or, the request may be stored and transmitted at a later time.

The term “parameter” is meant to include a quantity or value defining characteristics of a system or method. A parameter may be a variable and may define the limits of operating values of the system or method. A parameter may be supplied by a user and passed as an argument to a computer software routine. A change in one or more parameters is meant to change the behavior of the system or method.

### II. Systems and Methods

The invention is directed to an affinity matching system used to accept and execute complex match queries in real-time. The match queries incorporate proximity and time-tracing information to further define active users based on affinity criteria. Users submit the affinity criteria to a server-side application, which executes a match algorithm. The match algorithm returns a set of matching user profiles of users who have previously entered affinity and attribute information. The match queries are dynamic, highly flexible, and responsive to the desires of each user issuing a match request. For example, based on the current scenario the user can specify the relative importance of affinity, location, and time.

The match algorithm accesses preprocessed affinity information, which includes affinity user groups referencing the profiles of users based on predetermined affinity definitions. The affinity definitions are adaptable, and are generally expressed and structured in a relational manner, such as a data hierarchy. The match algorithm can provide match results in real-time, or near real-time, because the system has already completed the computationally intensive processing of the user affinity information. Thus, the user affinity information is formatted, referenced, and available for match use.

It is to be understood that both the foregoing general description and the following description are exemplary and are intended to provide further explanation of the invention claimed.

The accompanying figures, which are incorporated in and constitute part of this specification, are included to illustrate and provide a further understanding of the system and method of the invention. Together with the description, the drawings serve to explain the principles of the invention.

The invention provides an affinity matching system for identifying nearby users with shared affinities. The nearby users can be users from a population of users having a subscription to a service, for example, an interactive service for helping people contact others with related interests. Furthermore, the users can be web users issuing requests from a web search engine, for example, Google.com, or a matching service, such as Match.com, to find like-minded people. In these instances, the search engine would package the user's request as a request to the affinity matching system. The affinity matching system would respond with affinity results. The search engine could repackage the results as interactive content for the web user.

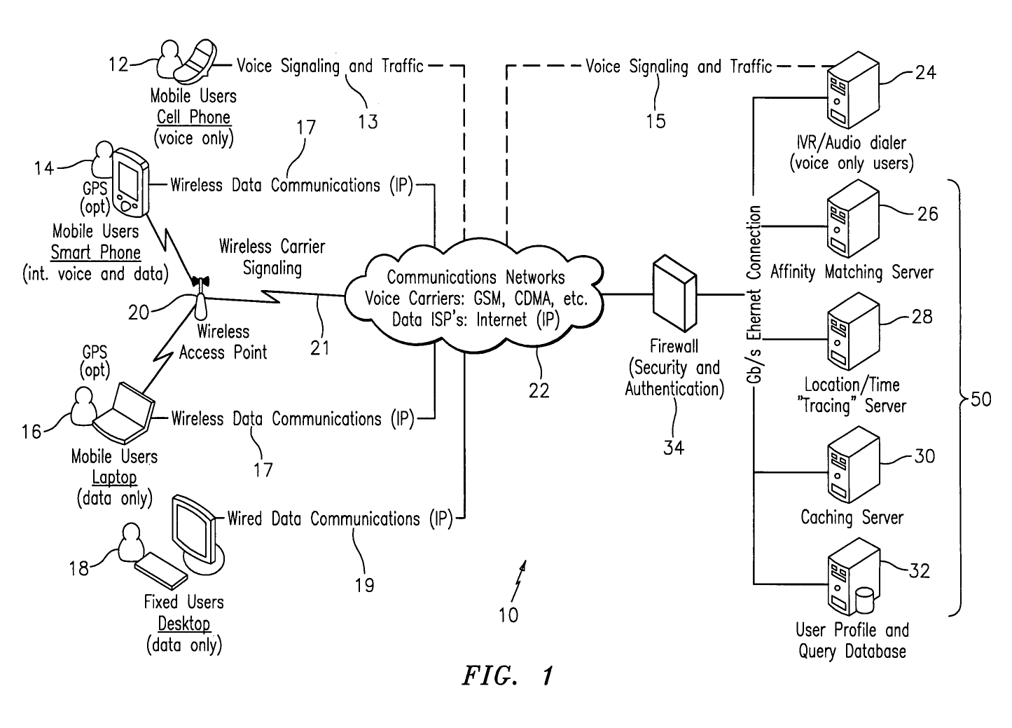

FIG. 1 shows an embodiment of a networked architecture 10 for practicing the invention. The architecture is device agnostic and can use a variety of client devices and interfaces to access the network including, but not limited to, mobile cell phones 12 capable of voice signaling communications 13, mobile smart phones 14 capable of voice and data communications 17, mobile laptop users 16 capable of data communications 17, and fixed desktops 18 capable of data communications 19. The client devices 12, 14, 16, 18 are connected to communications networks 22 including, but not limited to, networks for mobile voice services using Global System for Mobile communications (GSM), Code Division Multiple Access (CDMA), etc., and data networks for the internet using internet protocols. The client devices 12, 14, 16, 18 may be connected over landline networks for carrying voice signaling and traffic 15. Wireless networks may used including wireless access points 20, wireless data communication 17, and wireless carrier and data networks 21.

Communications networks 22 are technology agnostic and may be via voice and/or data communications networks, depending on device capabilities. For voice only mobile users 12, any mobile carrier network will suffice regardless of the carrier's underlying transport/cell technology. For mobile smart phone users 14, and users on laptops 16 and desktops 18, internet technology may be required. For devices capable of voice and data communications such as smart phones 14, the voice carrier and internet technologies can be used.

An automated locator system (not shown) may generate location coordinates for a mobile device user 12, 14, 16. The automated locator system may leverage communications with the nearest wireless access point 20 to determine the device's location. Alternatively, the mobile device may have a Global Positioning System (GPS) capable of determining the device's location. GPS is well-known in the art.

Mobile users using simple cell phones 12 and voice-only landline users (not shown) may access the affinity matching system via an IVR server system 24 to be described below.

The communications networks 22 may be connected to computing systems 24, 26, 28, 30, 32 via a firewall 34 for security and authentication. The computer systems include, but are not limited to an Interactive Voice Response (IVR) Autodialer server 24, an affinity matching server 26, a location and time tracing server 28, a caching server 30, and a user profile and match query database server 32.

Voice signaling and data traffic is routed to the IVR server system 24. The IVR server system 24 includes a computer capable of detecting voice and touch tones from a telephone call. The IVR server system 24 can also respond to prerecorded or dynamically generated audio tones and signals and can respond with pre-recorded or dynamically generated audio for providing instructions to callers. The IVR server system 24 is useful for breaking down commands and instructions into a series of simple menu choices. The IVR server system 24 is scalable to handle large call volumes.

The IVR server system 24 can furnish affinity matching results to the user. The Autodialer component further allows voice-only users the option of contacting matching users who meet the affinity matching request.

The networked architecture can include a multi-server platform 50 for practicing the invention. The multi-server platform 50 can include an affinity matching server 26 for preprocessing user profiles and defining affinity user groups. The affinity user groups include references to user profiles with matching affinities. The affinity matching server 26 can also incorporate match criteria and real-time information for user location and time to further determine active users.

The multi-server platform 50 can include a location and time tracing server 28 for providing a location and time stamp of active users. For example, a GPS can be used to supply a mobile device location and time stamp. A fixed address may be used for the location of fixed desktop or landline users. The location and time tracing server 28 can leverage Assisted GPS (A-GPS) techniques for increasing performance and accuracy of the GPS. For example, the A-GPS can use an assistance server to roughly locate a mobile device within a cell site to aid in location determination. Furthermore, the assistance server can provide compute power to the GPS for signal processing and error determination. A-GPS is well-known in the art and has been used for Enhanced 911 and other location-based services.

The multi-server platform can include a user profile and matching database server 32 for storing user profiles and performing real-time matching services for users or web applications including search engines, gaming systems, ecommerce, etc.

The multi-server platform can include a caching server 30 for allowing asynchronous update of user profiles, including demographic information and affinites. The caching server 30 can also cache match results for quick access and recall.

Alternatively, other server configurations can be used to implement the described functionality, for example, a single server or any subcombination of the described servers may be used. Furthermore, various techniques can be used to provide fault tolerance, such as mirroring, and performance enhancement, such as parallel processing and load balancing.

### Data Processing

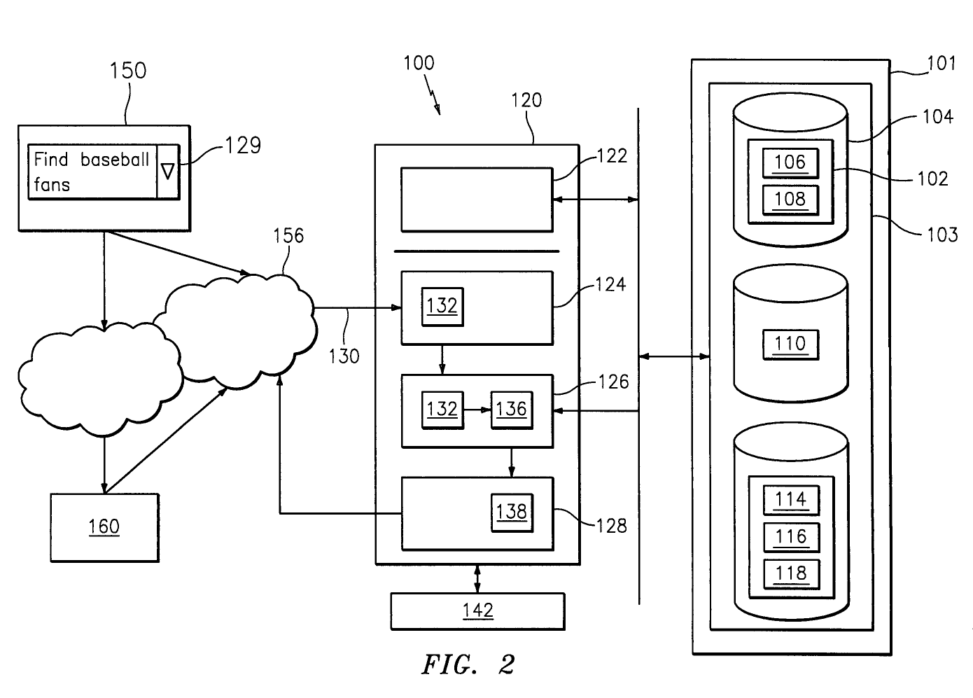

Referring to FIG. 2, the affinity matching system comprises a data processing system 100. The data processing system 100 includes user profiles 102 of users of the affinity matching system. The user profiles 102 include demographic profiles 106 and affinity profiles 108. The user may be a subscriber to an affinity matching service or a one-time requester of affinity information, but the invention is not limited to only this type of user or service.

A user can register with the affinity matching service in any number of ways. For example, a user may create a system account by entering into a web page displayed in a web browser a usersname, password, and demographic information, and submitting a request to a web server to create the user account. The web server may route the information to a database server 101, which stores the submitted information, for example, in tables 106, 108 of a relational database 104. The relational database can be managed in a Relational Database Management System (RDMS) 103, such as SQL Server, MySQL, or Oracle. Relational databases and RDMS are well-known in the art.

The relational database 104 may include a unique user id for each registered user and user security information including a username and password. Furthermore, the relational database 104 may store information on user-definable weights to use in match queries to be defined below. Also, the relational database 104 may include a user-settable current user mode to indicate whether the user's information is posted, tracked, or published on the affinity matching system for other users to search and view.

In alternative embodiments, the user profile 102 can be stored in a datafile or the user profile 102 may persist in a computer memory for a period of time until it is deemed no longer valid or needed by the system. For example, the user profile 102 can persist in a cache memory for quick and efficient recall.

The data processing system 100 includes a computer program 120 saved on a memory device 142, such as a computer hard drive, random access memory, a compact disk, a diskette, or any other memory device. The computer program 120 can be created from computer source code comprising execution instructions written in a computer language such as Java, C++, etc. A compiler compiles the computer source code to create an executable file which is loaded for execution onto a computer processor, such as a dual-core processor. Those skilled in the art will readily appreciate that variations can be made to the manner in which that data is processed or the type of processor used with the system with departing from the inventive aspects of the present disclosure.

The computer program 120 may be compiled as a monolithic program, but preferably, the computer program 120 is comprised of separate modules 122, 124, 126, 128 which together execute all or a portion of the functionality of the data processing system 100.

### Affinity User Group Preprocessing Module

An affinity user group preprocessing module 122 is configured to define affinity user groups 110 which reference users having certain shared affinities. For example, the affinity user groups 110 may reference users with an interest in sports, music, antiques, gourmet cooking, etc. The affinity user groups 110 may reference more specific interests, for example, an interest in a sports team, such as the Boston Red Sox or New York Yankees.

The affinity user group preprocessing module 122 uses a match algorithm to define the affinity user groups 110. The affinity user group preprocessing module 122 preprocesses the user profiles to define the affinity user groups 110 stored in cache memory for quick access. Thus, when an affinity service issues a real-time request for a match, the affinity matching system can immediately reference the stored affinity user groups 110. This results in a more responsive system. For example, when a user of an affinity service makes a request, the affinity service need not individually process the many thousands or millions of user profiles 102 in the database 104 to find matches. Instead, the affinity service need only reference the appropriate affinity user group 110 and return the results. Preprocessing also permits the data processing system 100 to execute ahead of time more complicated and time-intensive match algorithms when defining the affinity user groups 110. The affinity matching system is not precluded from executing the match algorithm when a request is received.

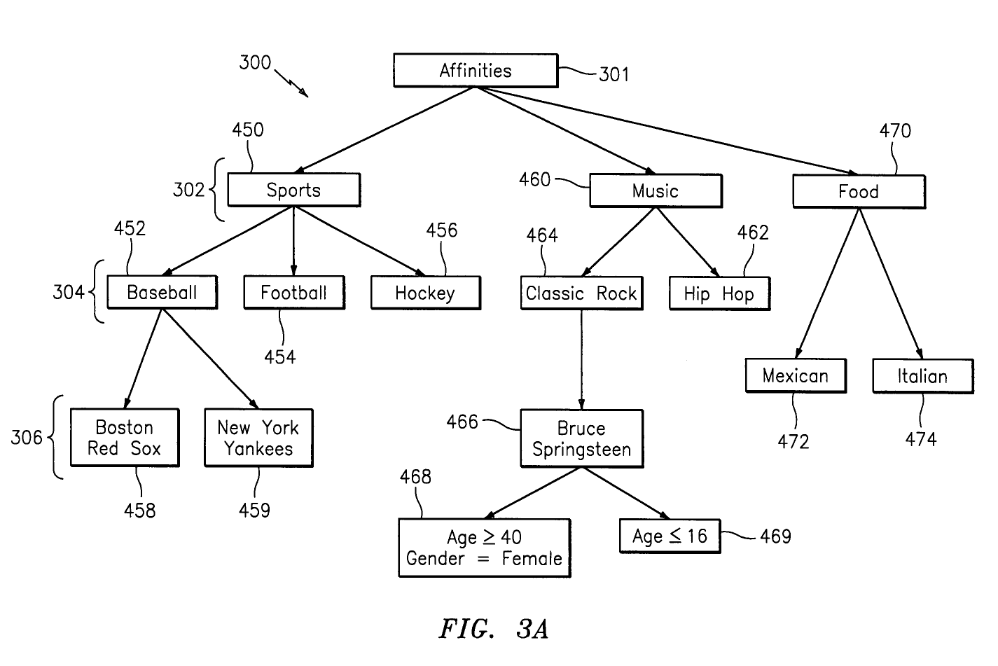

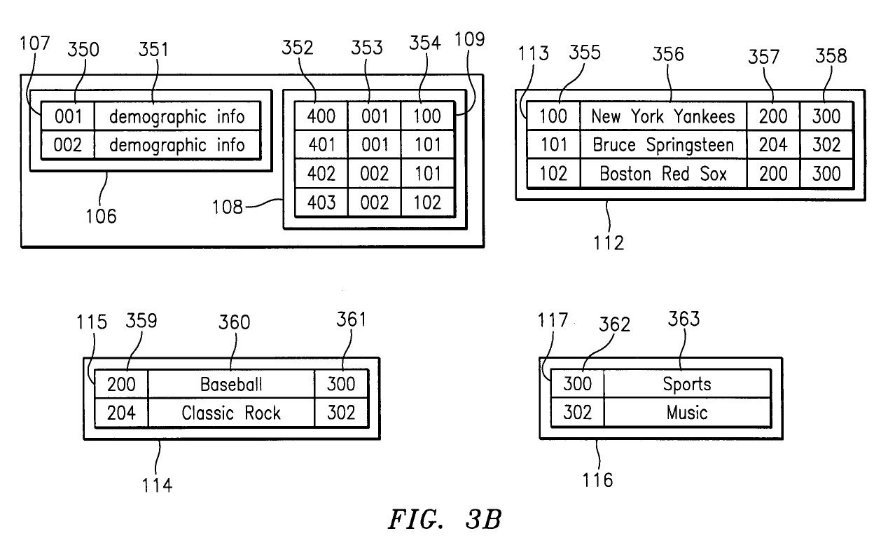

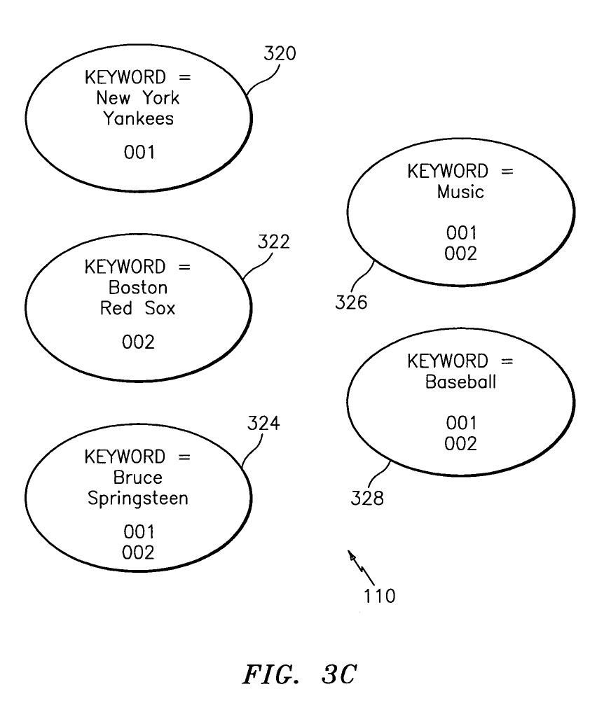

The affinity user group preprocessing module 122 may execute any appropriate match algorithm when preprocessing the user profiles 102 to define the affinity matching groups 110. To enable efficient matching, the affinities may be defined as relationships between affinity keywords. Referring now to FIG. 3A which shows an embodiment of a database architecture that can be used to practice the invention. In the affinity relationships and definitions, the keywords may be organized in an affinity class hierarchy 300, with a base affinity node 301. A sports affinity hierarchy may include a parent class affinity 302 with the keyword “Sports” 450, followed by subclass affinities 304 with keywords “Baseball” 452, “Football” 454, and “Hockey” 456. Each subclass affinity 304 may have affinity definitions 306 for individual sports teams, including keywords “Boston Red Sox” 458, “Yankees” 459, etc. under the “Baseball” subclass affinity 304. Other parent class affinities 302 may include keywords “Music” 460, which may further include subclass affinities 304 with keywords “Hip hop” 462 and “Classic Rock” 464, and “Food” 470, which may further include subclass affinities 304 with keywords “Mexican” 472 and “Italian” 474. Like the sports affinities, other affinities may have specific affinity definitions 306, for example, musician “Bruce Springsteen” 466 under “Classic Rock” 464.

In at least one embodiment of the invention, the affinity definitions can be further classified by demographic information. For example, the affinity definition for Bruce Springsteen 466 can be further divided into female fans at least 40 years of age 468 and young fans less than or equal to 16 years of age 469.

The affinity relationships and definitions are not limited to the above-described arrangement, and any appropriate configuration may be used depending on the needs and complexities of the affinity matching service. For example, a matrix format may be used wherein the affinities are defined at each row/column intersection, or a linked list relationship may be used.

A user's affinity profile 108 may be defined in any number of ways. For example, a user may define an affinity profile 108 when registering with the system. A user may also modify an existing affinity profile 108, or add an affinity profile 108 at any time. The method for entering an affinity profile 108 may include selecting on a web page displayed in a web browser a group of options identifying the affinity definitions 301 in the aforementioned affinity hierarchy 300. For example, a relational database 104 may include tables 114, 116, 118 encapsulating the affinity hierarchy 300 for the affinity definitions 306, parent class affinities 302, and subclass affinities 304. Assuming that a user is a New York Yankees fan, the user can select a parent option labeled “Sports”, which opens subclass options labeled “Baseball”, “Football”, “Hockey”. The user can select option “Baseball”, which opens the affinity definitions for individual baseball teams, including “Boston Red Sox” and “New York Yankees”. The user can select “New York Yankees” and issue a request to create an affinity profile 108. The data processing system 100 can create and store the affinity profile 108 in the relational database 104.

The affinity profiles 108 need not be limited to the user's interests, and can include other kinds of information. For example, the user can define affinity profiles for various occupations such as Dentist or Flight Attendant or for various hobbies such as Gardening or Sailing. The affinity profiles 108 can be linked to role-playing games and can include various characters, avatars, or personae. Gaming platforms can use the role-playing information to support various aspects of the role-playing games.

Referring to FIG. 3B, showing an embodiment of the database tables 106, 108, 112, 114, and 116 in relational database 104. The user profiles 102 include database tables 106 and 108. Database tables 112, 114, and 116 store the affinity definitions 306, subclass affinities 304 and parent class affinities 302.

Database table 106 includes user information records 107, and database table 108 includes user affinity profile records 109. Each of the user information records 107 includes basic user information including a data field for a unique user id 350 and one or more data fields storing demographic information 351. The demographic information can include age, gender, address, etc. The user information records 107 can also include security information (not shown).

The affinity profile records 109 can have a data field for a unique user affinity id 352 and can have a user id data field 353 for linkage to the user information records 107. The affinity profile records 109 can have an affinity definition data field 354 for linkage to an affinity definition record 113 in the affinity definitions table 112.

The affinity definition table 112 includes affinity definition records 113 for defining the individual affinities in the affinity matching system. Each affinity definition record 113 can have a data field 355 for a unique affinity definition id and a keyword 356. The affinity definition record 113 can be linked to subclass records 115 and parent class records 117 via data fields for a subclass id 357 and a parent class id 358, respectively.

The subclass affinity table 114 includes subclass affinity records 115 having data fields for a unique subclass id 359, subclass keyword 360, and for unique parent id 361 for linkage to a parent class record 117. The parent affinity table 116 includes parent affinity records 117 having data fields for a unique parent id 362, and parent keyword 363.

The affinity user group preprocessing module 122 can execute a match algorithm that uses the linkages between the affinity profile records 109 and the affinity definition records 113 to define the affinity user groups 110. Referring to FIG. 3C, affinity user groups 320, 322, 324, 326, 328 are defined. Each affinity user group 320, 322, 324, 326, 328 includes a keyword describing the affinity, and the user ids of users referenced in the group. For example, based on the records shown in FIG. 3B, user 001 is referenced in affinity user group 322 for New York Yankees fans, user 002 is referenced in affinity user group 324 for Boston Red Sox fans, and users 001 and 002 are referenced in affinity user groups “Bruce Springsteen” 324, “Music” 326, and “Baseball” 328. The match algorithm used by the affinity user group preprocessing module 122 is not limited to this example, and can incorporate, for example, multiple descriptive keywords as well as user demographic information, for example, gender, age, etc.

### Request Module

A request module 124 is configured to accept an affinity request 130 originating from a user on a client device 150 coupled to the affinity matching system over the Internet 156, an intranet, or an extranet, although other configurations are possible. As shown in FIG. 2, the request can originate from a user on a client device 150 using a web service 160 or a web site, such as a search engine. The search engine can transmit the request to the affinity matching system and send the results back to the client device 150. In another configuration (not shown), the affinity matching system can be installed as a back-end application and directly linked to a web application server.

The affinity request 130 includes a match query 132. The match query 132 includes one or more parameters related to a user's current match interests. For example, the user using a web page displayed in a web browser can select one or more affinities in an option box. In another configuration, the user can type or select a match description to include in the match query, for example, “Find baseball fans” 129. The affinity matching system recognizes the match description and takes an appropriate action to find the matching user profiles. In another configuration, the affinity matching system can be keyed into current sporting events and send to the user match descriptions for the current sporting events for the user to select. For example, if a Major League Baseball game is scheduled at 7:05 pm between the New York Yankees and the Boston Red Sox, the affinity matching system can send the match description “Find Yankees fans for the upcoming game”. The user can select this option and send it as the match query 132 to the affinity matching system.

The match interests of the user can be stored on the client device 150, or can be downloaded to the client device 150 whenever the user logs into the affinity matching system. In this way, the user can conveniently select already entered match interests from prior sessions without having to redefine the match interests in each session.

In a further embodiment, the match query 132 can include time information for indicating how long the affinity matching system should execute the match request. In still a further embodiment, the match query 132 can include a maximum distance parameter 406 indicating a maximum distance of other users from the requester user's current location 402. For example, the requester user may desire to find users for the next 10 minutes who are within a quarter of a mile from the requester user's current location 402. In addition, the match query 132 can include demographic criteria, such as gender and age. For example, the requester user can desire to find only those users of the opposite gender who are at least 18 years of age.

### Affinity Matching Module

An affinity matching module 126 is coupled to the request module 124 and is configured to process the affinity request 130 to determine whether any of the affinity user groups 110 match the match query 132. In one embodiment of the invention, the request module 124 parses the match query 132 into request parameters and routes the request parameters 134 to the affinity matching module 126. The affinity matching module 126 combines the request parameters 134 with affinity user group information 136 retrieved from the database 104. In one embodiment, the affinity matching module 126 can create a SQL expression using the request parameters 134 to query the affinity user groups 110 stored in the RDMS 103. The RDMS 103 processes the query and returns matching user profiles 102.

For example, the match query 132 can include the parameter “Baseball.” The request module 124 accepts the affinity request 130 and routes it to the affinity matching module 126 for processing. The affinity matching module 126 employs a match algorithm to find matching user profiles 102. For example, using simple keyword comparison, the affinity matching module 126 can compare the desired affinity “Baseball” to the defined affinity user groups to determine if any directly match the affinity or are a subclass or a parent class of the affinity. Referring to FIG. 3C, the affinity matching module 126 can determine that affinity user group 328 with keyword “Baseball” is a direct match, and affinity user groups “New York Yankees” 320 and “Boston Red Sox” 322 are a subclass match.

In the configuration described above, where the match query 132 includes the match description “Find Yankees fans for the upcoming game”, the affinity matching module 126 can use a more restrictive match algorithm than in the prior example to determine that only affinity user group 320 with keyword “New York Yankees” is a match. The affinity matching module 126 need not necessarily preclude non-Yankees fans from the match depending on other algorithmic factors including weight factors to be described below.

### Rendering Module

A rendering module 128 coupled to the affinity matching module 126 is configured to present the user profiles 138 referenced in the matching affinity user groups 110. For example, if the desired affinity were Baseball, the rendering module would present the user profiles 138 referenced in matching affinity user groups 320, 322, 328, including users with user ids 001 and 002.

The rendering module 128 could present the matching user profiles 138 in any number of ways, depending on the capabilities of the client device 150 and the requirements and features of the affinity matching service. In one embodiment, the user information stored in the matching user files 102 could be formatted in hypertext markup language (HTML) and returned to the client device as a HTML file for display in a web browser. In another embodiment, the rendering module 128 could encrypt and compress the user information into a byte stream, the byte stream loaded into a web client application, for example, an ActiveX Control, and displayed in the web client application. In still another embodiment, the user information could be formatted in Extensible Markup Language (XML) which allows application specific tags to be defined for the sharing of structured data across different platforms. The affinity matching system can define specific affinity related XML tags to be included in XML files. The rendering module 128 is not limited to these presentation formats and can include any appropriate format that is suitable to the client devices 150 supported by the system.

In accordance with a further embodiment of the invention, the rendering module 128 presents the matching user profiles 138 in manner appropriate for the receiving client device 150. For example, for landline telephone with audio-only capability, the rendering module 128 can present the information as a series of vocalizations, for example, “For a listing of matching users, please press or say ‘1’; to contact a particular user, please press or say ‘2’”, etc. For devices with text displays, the rendering module 128 can present the information as a bulleted list with numbers for selecting each bulleted item.

Preferably, modules 122, 124, 126, and 128 of the computer program 120 include sets of software coded functions for executing the functionality of the invention by passing and returning data between each other and other system components. A separate file may exist for each of the modules 122, 124, 126, 128, and each separate file, or groups of files, could be compiled into dynamic linked libraries (DLL). The DLLs can be loaded into a software application to provide support for an affinity matching service. In one embodiment, the modules 122, 124, 126, and 128 can be compiled into a single executable program loaded into a web application.

### Active Users

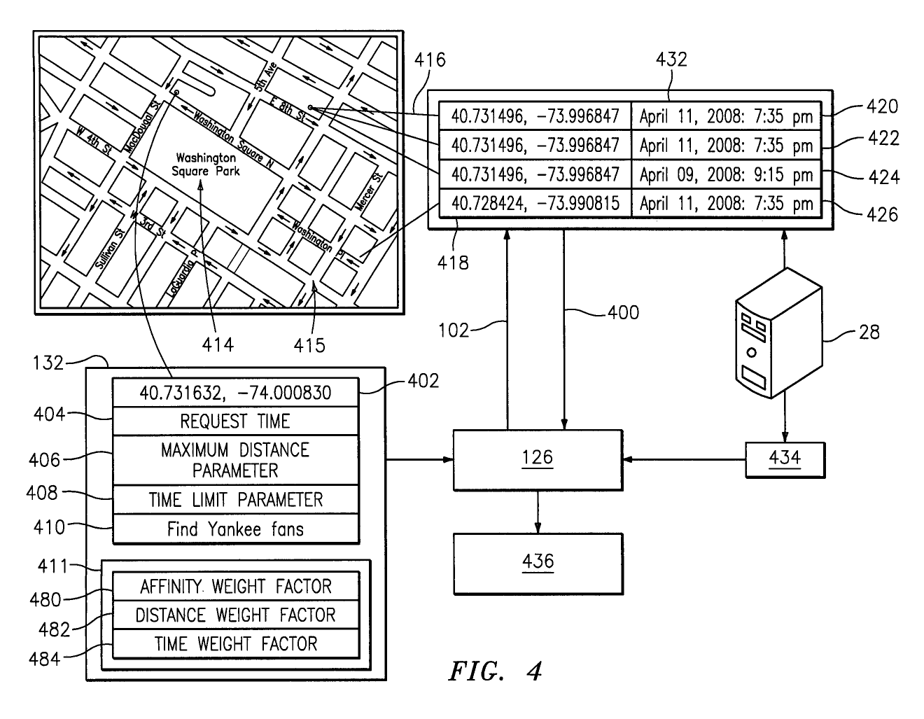

In accordance with a further embodiment of the invention shown in FIG. 4, the data processing system 100 further includes data representing requester location 402, a request time 404, a maximum distance parameter 406, a time limit parameter 408, and a match description 410.

The requester location 402 is a geographic location of the client device 150 originating the match query 132. In the alternative, the match query 132 could originate from a web service 160 in which case the requester location 402 would be the geographic location of the client device 150 accessing the web service 160. The requester location 402 can be determined in any number of ways. For example, the client device 150 can be a mobile device 12, 14, and 16 with an embedded GPS for calculating the latitude and longitude coordinates of the client device 150. The requester location 402 could be set to the geographic location of a wireless access point 414 servicing the mobile device 12, 14, and 16. Furthermore, the geographic location could be determined using assisted GPS combining a GPS with the cell coverage area information of the wireless access point 414. In this embodiment, the requester location 402 is determined to be at latitude, longitude coordinate, 40.731632, −74.000830.

In another embodiment of the invention, the requester location 402 is a static location, for example, the latitude, longitude coordinate of the home address of a user on a desktop computer.

The user can also provide the requester location 402 by selecting on a display screen his location from a list of known geographic locations (such as those provided via third party mapping functions including googlemaps or mapquest) with stored latitude, longitude coordinates. For example, the user can select Times Square in New York City to set the requester location 402.

The request time 404 is the time the user issued the request from the client device 150. Preferably, the location and time tracing server 28 determines the request time 404. However, the client device 150 can set the request time 404 to an internal clock time or the GPS could generate the request time 404, which is sent with the match query 132.

The maximum distance parameter 406 is the maximum distance between the requester location 402 and the location of other users 416, 418 on the system. In one embodiment of the invention, the user sets the maximum distance parameter 406. In another embodiment, the maximum distance parameter 406 is automatically set by the affinity service. The maximum distance parameter 406 is not limited to any particular distance value and can be, for example, 100 yards, a quarter of a mile, a half mile, one mile, etc. Preferably, the maximum distance parameter 406 is related to the population density of the geographic area to minimize or maximize the number of matches. For example, in urban centers with many active users, the maximum distance parameter 406 can be the length of two city blocks (approximately 150 yards). In rural areas, the maximum distance parameter 406 can be much farther, for example, five miles.

The time limit parameter 408 represents the length of time to search for matches. The time limit parameter 408 is measured from the request time 402. Preferably, the time limit parameter 406 is related to the immediacy requirements of the affinity matching, for example, one hour, six hours, 12 hours, or 24 hours. For an event occurring in the very near future, the time limit parameter 406 can be set to a low value, for example 20 minutes, since the requester user may no longer be interested in matches once the event starts. For an event planned in the more distant future, the time limit parameter 406 can be set to a high value, for example one month.

### Use Case Scenario

The affinity matching system, in at least one embodiment, can implement the use-case scenario shown in FIG. 4. The use-case scenario involves an upcoming Major League Baseball game between the New York Yankees and the Boston Red Sox. A requester user desires to find other users with an interest in watching the game that are currently near the location of the requester user. The requester user desires to find other users within two city blocks (approximately 150 yards) in the next 10 minutes. The requester user selects these parameters on his client device 150 and sends the affinity request 130 to the affinity matching system. An example match query 132 resembles the following format:

QUERY:
affinity=“Find Yankees fans for the upcoming game starting at 7:05 pm, Apr. 11, 2008”;
maximum distance parameter=150 yards;
time limit parameter=10 minutes.

The request module 124 accepts the affinity request 130 and parses the match query 132 into a set of parameters 134. The affinity matching module 126 sends a query to the RDMS 103 to return matching user profiles within baseball affinity user groups 110. Matching user profile for user A 420, user B 422, user C 424, and user D 426 are returned.

The affinity matching module 126 defines the active user profiles 436 from the set of matching user profiles using the match parameters and the real-time system information 400 for tracked locations 416, 418 and the current time 434. The location and time tracing server 28 determines that the request time is 6:55 pm on Apr. 11, 2008. The requester's GPS enabled mobile phone indicates the requester location 402 of 40.731632, −74.000830 near Washington Square Park in Manhattan. The tracked locations for user A 420, user B 422, and user C 424 are the same, namely, 40.731496, −73.996847, which corresponds to a sports bar on East 8th Street in Manhattan. The tracked location for user D 426 is 40.728424, −73.990815, which corresponds to the lobby of a hotel near Washington Square Park in Manhattan.

At current time of 7:00 pm, the affinity matching module 126 determines that user A 420, user B 422, user C 424, and user D 426 are the active users and the rendering module 128 presents the active user profiles 436 to the client device 150.

The affinity matching module 126 may obtain the calculated distances using various methods known in the art. For example, the affinity matching module 126 may use a Geographic Information System (GIS) procedure call to obtain a distance between latitude, longitude coordinates for the requester location and the tracked locations 416, 418 of the matching user profiles. The GIS may be integrated with the location and time tracing server 28.

In accordance with at least one embodiment of the invention, the affinity matching module 126 is configured to update the requester location 402 and the tracked locations of the matching user profiles after the expiration of a length of time. After the affinity matching module 126 updates the requester location 402 and the tracked locations 416, 418, the affinity matching module 126 redefines the active user profiles 436. The affinity matching module may use any length of time appropriate for the affinity service, for example, one second, one minute, or one hour.

In accordance with a further embodiment of the invention, the tracked locations 416, 418 for each matching user profile further include a tracked time 432 representing the tracked location recordation time. In a sense, the tracked time 432 represents the staleness of the tracked locations 416, 418. Thus, users who have been off the system for a few days will have less recent tracked times and relatively stale tracked locations 416, 418 compared with users currently on the system. In most instances, stale tracked locations 416, 418 will not be very useful for match purposes.

The affinity matching module 126 can use the tracked times 432 to eliminate inactive matching user profiles, even though the matching user profiles meet other aspects of the match query 132. However, stale tracked locations 416, 418 may be useful for a static addresses (i.e., non-mobile user at desktop in their home). Also, users may not be interested in real-time information. For example, a user may want to contact other users who have previously visited a locale in the past few months. The affinity matching system can save tracked locations and, with proper permissions set, return the user profiles of users who have traveled to, for example, Times Square in New York City.

The tracked time parameter 432 may be combined with other parameters to further define active user profiles. For example, the affinity matching module 126 can filter out matching user profiles with stale tracked locations 416, 418. The affinity matching module can be configured to determine active users by selecting only those users with tracked locations 416, 418 last recorded within a certain period of time. For example, in the use-case scenario illustrated in FIG. 4, the affinity matching module 126 can eliminate user C 424 because user C's tracked time 432 is almost two days prior to the current time 434 of Apr. 11, 2008 at 7:00 pm, and thus user C's tracked location 416 is probably inaccurate. The data processing system can employ the location and time tracing server 28 described above to calculate the tracked location and tracked time of each user, as well as the current time 434.

Much of the information used to process the match query can be obtained from the caching server 30 for quick recall of the information. When the affinity matching system initially processes the match query, the affinity matching module 126 defines matching user profiles based on the affinity match algorithm. The affinity matching module 126 further defines the active user profiles based on the calculated distances and time limit parameter and the rendering module 128 presents the active users profiles to the client device or web service.

The affinity mathing system can use the caching server 30 to cache information associated with matching user profiles. At the predetermined time intervals, the location and time tracing server 28 can update the requester location 402 and tracked locations 416, 418 and re-cache the values in the caching server 30. When the user issues a match query, the affinity matching module 126 can determine whether the cache values can be used. If so, the rendering module 128 sends the cache values. If not, the affinity matching module 126 processes the match query. In one embodiment of the invention, the rendering module can automatically push updated information to the client device 150.

### Weights

In accordance with a further embodiment of the invention, the data processing system 100 further includes an affinity weight factor 480, a distance weight factor 482, and a time weight factor 484 for modifying the affinity match algorithm. The affinity matching module 126 uses the affinity weight factor 480, distance weight factor 482, and time weight factor 484 to set the importance of the affinities, distances, and time limits, respectively, when finding matching user profiles. The weight factors 411 can be expressed as numbers, for example, numbers within the range of 0 to 1, or the weight factors can be ordered based on level of importance. The affinity matching module 126 uses the weight factors to modify each of the affinities, distances, and time limits to arrive at a sum for each user profile. The rendering module 128 is further configured to rank the matching user profiles based on the sum.

The user can define each of the weight factors on the client device 150, and include the defined weight factors in the match query 132 of the affinity request 130. In accordance with a further embodiment of the invention, the user can express the weight factors as numbers between 0 and 1. The affinity weight factor 480 modifies an affinity strength of each of the matching user profiles. For example, if the matching user profile is a direct affinity match, the affinity strength will be higher than a subclass or parent affinity match. In a further embodiment of the invention, the affinity strength may be normalized to a range between 0 to 1 and multiplied by the affinity weight factor 480. The result is augmented by the distance weight factor 482 multiplied by the normalized calculated distance for each matching user profile. The result is augmented by the time weight factor 484 multiplied by the normalized time differences to arrive at a match weight for each matching user profiles. In still a further embodiment, the matching user profiles are ranked based on the match weights.

In a further embodiment of the invention, the user orders the weight factors 411 from highest to lowest importance. The affinity strength is based on the affinity match. For example, a direct affinity match for users who like the same sports teams has a higher affinity strength than users who have an interest in baseball, but like different sports teams. The distance weight factor 482 is based on whether the calculated distance between the requester location 402 and the tracked location 416, 418 of the matching user profile is within the maximum distance expressed by the maximum distance parameter 406. If so, the affinity matching module 126 can set the distance weight factor 482 to 1; if not, the affinity matching module 126 can set the distance weight factor 482 to 0. Likewise, the time weight factor 484 is based on whether the time difference between the request time 404 and the current time 434 is within the time limit parameter 408. If so, the affinity matching module 126 can set the time weight factor 484 to 1; if not, the affinity matching module 126 can set the time weight factor 484 to 0.

The affinity matching module 126 can rank each of the matching user profiles based on the order of importance of the affinity weight factor 480, distance weight factor 482, and the time weight 484. In the use-case scenario illustrated in FIG. 4, assume that the user is an avid Boston Red Sox fan and seeks out other fans to watch the game. The user can set the weight factor order of importance to affinities>distances>and times. At the current time of 7:10 pm on Apr. 11, 2008, the affinity matching module 126 ranks user D 426 as the highest matching user profile because user D is the only Boston Red Sox fan and the affinity is the most important weight factor 411. This is the case even though user D's tracked location 418 is farther than the other tracked locations 416 and the current time 434 is greater than 10 minutes from the request time 404.

The time weight factor 484 based on the time difference between the request time 404 and the current time 434 will be the same for matching user profiles. In a further embodiment of the invention, the affinity matching module 126 can use the tracked time to further differentiate the matching user profiles. For example, in the use-case scenario illustrated in FIG. 4, user C 424 has the lowest time weight factor 484 because user C's tracked location 416 is almost two days old. The affinity matching module 126 will rank user C 424 the lowest ranking among the matching user profiles.

### User Modes

In accordance with a further embodiment of the invention, the affinity matching system further includes various user modes for defining system usage. A system user may set the user mode either via a request to the affinity matching system, or as a saved parameter in the user's profile. In the alternative, the affinity matching system can use a default mode. The modes determine whether the user's profile is shared with other system users and whether the user can issue affinity requests 130.

In user-idle mode, the affinity matching system does not share or publish the user's profile to other users on the system. Furthermore, the user is unable to issue an affinity request 130 to search for other users. User-idle mode is appropriate during nonuse periods, such as when the user is on vacation and does not intend to use the affinity matching system.

In active-browse mode, the affinity matching system publishes the user's profile to other users and the user is able to issue an affinity request 130 to search for other users. Active-browse mode is appropriate during periods the user intends to perform searches and wishes to be contacted by other users.

In active-silent mode, the affinity matching system does not share or publish the user's profile, but the user is able to issue an affinity request 130 to search for other users. Active-silent mode is appropriate when the user desires to issue an affinity request 130 to search for other users, but wants to remain hidden from other users—otherwise known as “secret observers”. Thus, in active-silent mode, the affinity matching system will not return the user's profile to other querrying users, even though the user's profile may meet the match query 132 parameters of other users.

Regardless of the user mode, the affinity matching system continues to track and update the locations (and location track times) of registered system users. Users who have been inactive for an extended period of time will have stale tracked location information. Furthermore, because a user may have updated his profile, the affinity matching system, and more particularly the affinity user group preprocessing module 122, may have to update the affinity user groups 110.

In accordance with a further embodiment of the invention, the affinity matching system can accomodate third party applications via a published application programming interface (API). The API allows the affinity matching system to access an extended user population or community through an open interchange of user profiles from third party matching systems. An example third party matching system includes Match.com accessed on the web at http://www.match.com. Thus, a system user of the affinity matching system can extend a search to users registered on the third party matching system.

The API also allows system users to access geographic information systems (GIS) and web sites with GIS backends to support mapping queries, driving directions, etc. Such web sites include Google Maps accessed on the web at http://maps.google.com, and MapQuest accessed on the web at http://www.mapquest.com. An example GIS includes Autodesk's MapGuide and ESRI's ArcGIS, as well as location-based applications.

The API also allows system users to access social networking web sties, including Facebook accessed at http://www.facebook.com, MySpace accessed at http://www.myspace.com, and YouTube accessed at http://www.youtube.com. For example, the affinity matching system can return a YouTube video clip of a matched user.

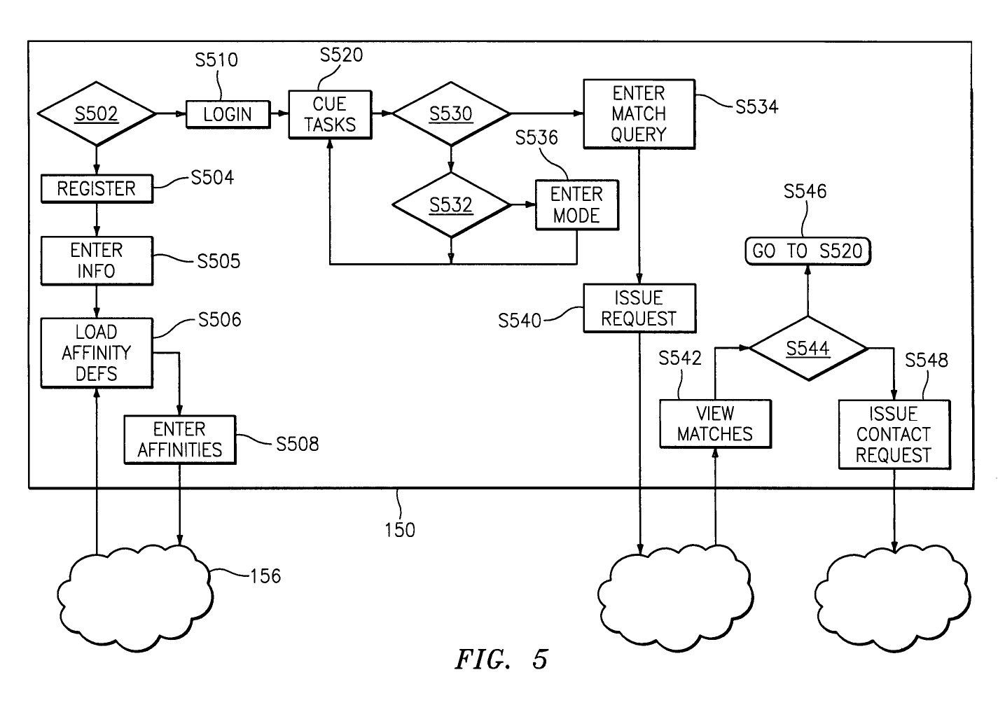

Referring to FIG. 5, the invention also provides a method of matching users with shared affinities including the steps of entering a user profile S505, S508. The user profile includes a demographic user profile of a user and an affinity user profile including information on the affinities of the user. The method also includes issuing a request S540 having a match query 132 with desired match information. The method also includes viewing matching user profiles based on the match query S542.

In accordance with a further embodiment of the invention, the match query 132 includes a maximum distance parameter indicating a maximum distance between a requester user and the at least one matching user profile. The match query 132 also includes a time limit parameter indicating a length of time for performing the match query. The length of time is calculated as a difference between a request time and a current time.

In accordance with another embodiment of the invention, the method further includes specifying as a portion of the match query 132, an affinity weight factor, a distance weight factor, and a time weight factor. In still a further embodiment of the invention, the step of specifying further includes specifying as a portion of the match query, an order of importance of the affinity weight factor, the distance weight factor, and the time weight factor.

In accordance with a further embodiment of the invention, the method further includes issuing a request to contact users S548 with matching user profiles and scheduling a meeting with the users.

A first-time user of the affinity matching system may be prompted to register with the system S502. If the user elects to register with the system S504, the user enters demographic S505 and affinity information S508. When entering affinity information, the user may select from a variety of affinity definitions stored and transmitted by the affinity matching system and loaded onto the client device S506.

A registered user may log into the system S510 and begin performing system tasks, which are cued and processed by the system S520. If the user elects to submit a match query S530, the user enters the match query S534 and issues an affinity request to the affinity matching system S540. The user may choose to include match information such as weight factors. If the user elects to set the user mode S532, the user enters the desired user mode S536.

The user views the matching user profiles S542, and may elect to contact another user S544 and issue a request to contact the other user S548. Otherwise, the system continues to cue and process any subsequent tasks S546, S520.

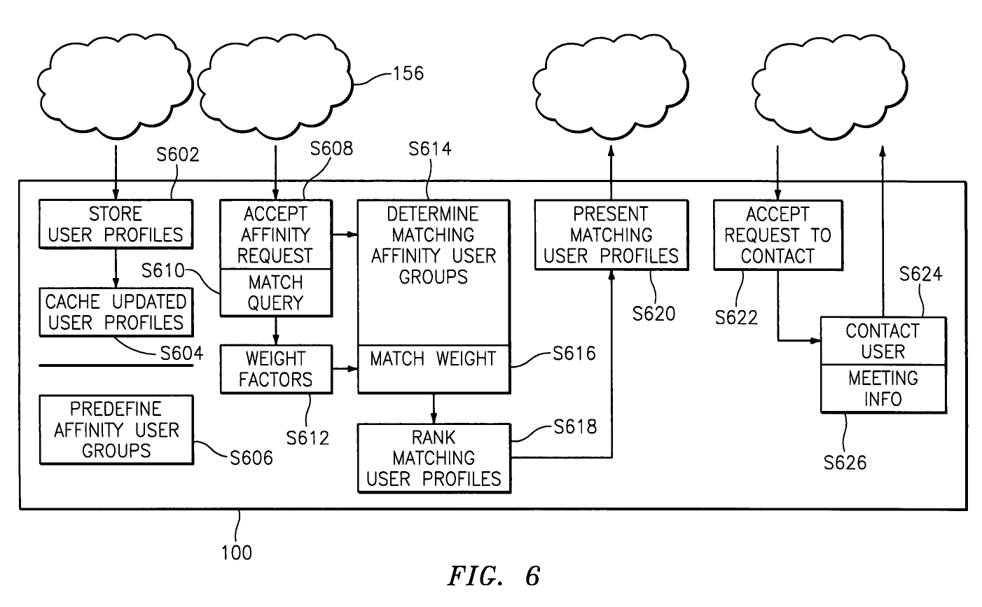

Referring to FIG. 6, at least one embodiment of the invention includes a method of matching users with shared affinities. The method includes the step of storing a user profile S602, which includes a demographic profile of a user and an affinity profile of the user. The user profile is received from a client device 150 or web service 160. The inputted user profile is preferably from a user or a web service or web agent on behalf of the user and is received by a data processing system 100 via the Internet 156, or other networked system.

The method also includes predefining affinity user groups S606 representing matching affinity profiles of users. The affinity user group 110 can reference each of the matching affinity users, for example, by including a unique id for each user. In a further embodiment, the method may cache updated user affinity profiles S604 until the step of predefining the affinity user groups S606 is executed.

The method also includes accepting an affinity request S608 which includes a match query S610, and determining matching affinity user groups S614 within the predefined affinity user groups 110 based on the match query S610. In a further embodiment the match query S610 includes other match information S612 such as proximity and time criteria, and weight factors.

The method also includes presenting matching user profiles S620 in each of the matching affinity user groups. In a further embodiment the matching user profiles are ranked S618 according to match weight S616, and the ranked matching user profile are presented.

In accordance with a further embodiment of the invention, the method further includes accepting a request to contact at least one user S622 based on the presented matching user profiles. The request may originate from a client device 150 of a user of the affinity matching system. In another embodiment, the request originates from a web application 160, for example, a search engine, social networking web site, or any application requiring match information. In still a further embodiment of the invention, the request to contact includes a user profile sharing value indicating whether to share a user's profile.

The method may further include contacting the user S624. The contact may be initiated after an initial contact between one or more users, and may include more detailed information, such as information regarding affinities and attributes of the users. In still a further embodiment of the invention, the step of contacting includes information on a scheduled meeting between users S626.

In at least one embodiment, the invention uses a multi-domain match algorithm including affinity, proximity, and time. A system user may define a match algorithm based on weights allocated to the user desired affinity, proximity, and time requirements. For example, the user may choose to conduct a search for another user or group of users based a combination of affinity modified by an affinity weight, a distance modified by a distance weight, and time modified by a time. The user may customize the match algorithm in real-time and may reconfigure a user profile maintained on a system database. The database may be updated via an asynchronous secure interface. For any given user, the match algorithm may continuously search and rank other users using the user-defined match algorithm.

A user establishes a user profile via a registration and activation process. The user may choose to change his affinity, proximity, and time requirements and corresponding applied weights in real time. A user may maintain multiple profiles and switch from one profile to another. The affinity matching system maintains the lastest calculated location (and a timestamp representing when the system recorded the location) of the registered user profiles so that users may be identified and tracked by each other.

The affinity matching system uses secure, encrypted asynchronous transmission of real-time data to allow for rapid rendering of information to the various user interfaces and to respond to the various requests for matches. The data and match results can be cached in the cache server for quick access and recall.

The affinity matching system architecture is device agnostic and only requires access to a voice or data network for connectivity and communications. The user interfaces may be displayed or rendered on basic voice-only mobile phones, integreated voice and data devices, Personal Data Assistants (PDA), a laptop, or a fixed computer device such as a desktop computer.

All statements herein reciting principles, aspects, and embodiments of the invention, as well as specific examples thereof, are intended to encompass both structural and functional equivalent thereof. Additionally, it is intended that such equivalents include both currently known equivalents as well as equivalents developed in the future, i.e., any elements developed that perform the same functions, regardless of structure.

Although the foregoing invention has been described in some detail by way of illustration and examples for purposes of clarity and understanding, it will be apparent to those skilled in the art that certain changes and modifications can be practiced. Therefore, the description and examples should not be construed as limiting the scope of the invention, which is delineated by the appended numbered claims.

What is claimed is:

1. An affinity matching system for identifying nearby users with shared affinities comprising:
a data processing system comprising:
a computer program tangibly embodied on a memory device comprising:
an affinity user group preprocessing module configured to define at least one affinity user group, each affinity user group comprising a plurality of user profiles of users having matching affinities, each of the user profiles comprising:
an affinity profile of a user;
a request module configured to accept an affinity request, the affinity request comprising a match query;
an affinity matching module coupled to the request module and configured to process the affinity request to determine at least one matching user profile within the at least one preprocessed affinity user group based on the match query; and
a rendering module coupled to the affinity matching module and configured to present the at least one matching user profile.

2. The affinity matching system of claim 1 wherein the data processing system further comprises:
a requester location;
a request time;
a maximum distance parameter;
a time limit parameter; and
each of the at least one matching user profiles has a tracked location, the affinity matching module further configured to define at least one active user profile if a calculated distance between the requester location and the tracked location of the at least one matching user profile is less than or equal to the maximum distance parameter and if a calculated time difference between the request time and a current time is less than or equal to the time limit parameter, and the rendering module is further configured to present the at least one active user profile.

3. The affinity matching system of claim 2, wherein the maximum distance parameter is 100 yards, a quarter mile, a half mile, or one mile.

4. The affinity matching system of claim 2, wherein the time limit parameter is one hour, six hours, 12 hours, or 24 hours.

5. The affinity matching system of claim 2, wherein the affinity matching module is further configured to update the requester location and the tracked location of each of the matching user profiles after the expiration of a length of time to redefine the at least one active user profile.

6. The affinity matching system of claim 5, wherein the length of time is one second, one minute, or one hour.

7. The affinity matching system of claim 5, wherein the tracked location of each of the at least one matching user profiles has a tracked time and the affinity matching module is further configured to define the at least one active user profile based on the tracked time and to update the tracked time.

8. The affinity matching system of claim 1, wherein the data processing system further comprises:
a requester location;
a request time;
the match query includes:
an affinity weight factor;
a distance weight factor;
a time weight factor; and
each of the matching user profiles has a tracked location and a match weight, the affinity matching module further configured to calculate a distance between the requester location and the tracked location of the at least one matching user profile, a time difference between the request time and a current time, and to calculate the match weight of the at least one matching user profile based on a sum of:
an affinity strength of the at least one matching user profile modified by the affinity weight factor;
the calculated distance of the at least one matching user profile modified by the distance weight factor; and
the calculated time of the at least one matching user profile modified by the time weight factor.

9. The affinity matching system of claim 8, wherein the match query further includes:
an order of importance for the affinity weight factor, the distance weight factor, and the time weight factor, and the affinity matching module is further configured to calculate the match weight of the at least one matching user profile based on the order of importance.

10. The affinity matching system of claim 9, wherein the affinity matching module is further configured to rank the at least one matching user profile based on the match weight of the at least one matching user profile, and the rendering module is further configured to present the ranked at least one matching user profile.

11. The affinity matching system of claim 8, wherein the affinity strength is a number in the range of 0 to 1, the affinity weight factor is a number in the range of 0 to 1, the distance weight factor is a number in the range of 0 to 1, and the time weight factor is a number in the range of 0 to 1, the affinity matching module is further configured to rank the at least one matching user profile based on the match weight of the at least one matching user profile, and the rendering module is further configured to present the ranked at least one matching user profile.

12. The affinity matching system of claim 11, wherein each of the affinity profiles is associated with at least one affinity key word and the affinity strength is based on a number of matching keys words in the at least one matching affinity user group.

13. The affinity matching system of claim 1, wherein each of the affinity profiles is associated with at least one affinity key word.

14. The affinity matching system of claim 1, wherein the affinity request is issued from a device.

15. The affinity matching system of claim 1, wherein the rendering module presents the matching user profiles as prerecorded vocalizations.

16. The affinity matching system of claim 1, wherein the rendering module presents the matching user profiles as textual information.

17. The affinity matching system of claim 1, wherein the user profiles further comprise a user personae for defining at least one role-playing attribute of the user.

18. The affinity matching system of claim 1, wherein each of the plurality of user profiles further comprises a demographic profile comprising:
an age of the user;
a name of the user;
a gender of the user; and
an address of the user.

19. The affinity matching system of claim 1, further comprising a plurality of user modes for defining system usage.

20. The affinity matching system of claim 19, wherein the plurality of user modes includes a user idle mode in which at least one of the plurality of user profiles is not shared and a system user cannot issue the affinity request, a user active-browse mode in which at least one of the plurality of user profiles is shared and a system user can issue the affinity request, and a user active-silent mode in which at least one of the plurality of user profiles is not shared and a system user can issue the affinity request.

21. The affinity matching system of claim 1, wherein the rendering module presents the matching user profiles to a search engine over the Internet.

22. A method of matching users with shared affinities comprising the steps of:
storing at least one user profile, each user profile comprising:
a demographic profile of a user;
5 an affinity profile of the user;
predefining at least one affinity user group representing a plurality of matching affinity profiles;
accepting an affinity request, the affinity request comprising a match query;
determining at least one matching affinity user group within the at least one predefined affinity user group based on the match query; and
presenting at least one matching user profile in each of the at least one matching affinity user groups.

23. The method of claim 22 further comprising the steps of:
accepting a request to contact at least one user based on the presented at least one matching user profile; and
contacting the at least one user.

24. The method of claim 22, wherein the match query comprises:
an affinity weight factor;
a distance weight factor; and
a time weight factor, and the step of determining at least one matching user profile comprises modifying a match weight of the at least one matching user profile by the affinity weight factor, the distance weight factor, and the time weight factor.

25. The method of claim 24, wherein the step of determining further comprises ranking the at least one matching user profile based on the match weight of the at least one matching user profile, and the step of presenting comprises presenting the ranked at least one matching user profile.

26. The method of claim 25, wherein the match query further comprises an order of importance of the affinity weight factor, the distance weight factor, and the time weight factor and the match weight is further based on the order of importance.

27. The method of claim 23, wherein the request to contact includes a user profile sharing value indicating whether to share at least one user profile.

28. The method of claim 23, wherein the step of contacting includes information on a scheduled meeting between a plurality of users.

29. A method of matching users with shared affinities comprising the steps of:
entering a user profile including:
a demographic user profile of a user; and
an affinity user profile including information on at least one affinity of the user;
issuing a request having a match query having desired match information; and
viewing at least one matching user profile based on the match query.

30. The method of claim 29 wherein the match query comprises:
a maximum distance parameter indicating a maximum distance between a requester user and the at least one matching user profile; and
a time limit parameter indicating a length of time for performing the match query, the length of time calculated as a difference between a request time and a current time.

31. The method of claim 29, further comprising the step of:
specifying as a portion of the match query, an affinity weight factor, a distance weight factor, and a time weight factor.

32. The method of claim 31, wherein the step of specifying further comprises:
specifying as a portion of the match query, an order of importance of the affinity weight factor, the distance weight factor, and the time weight factor.

33. The method of claim 29 further comprising the steps of:
issuing a request to contact at least one system user having the at least matching user profile;
scheduling a meeting with the at least one system user.
